(19) United States
(12) Patent Application Publication
(10) Pub. No.: US 2025/0173810 A1
(43) Pub. Date: May 29, 2025

(54) IMAGE PROCESSING APPARATUS CAPABLE OF PROVIDING DEVELOPED IMAGE DATA THAT IS ABLE TO DISTINGUISH WHETHER OR NOT IMAGE EDITING HAS BEEN PERFORMED IN DEVELOPMENT PROCESSING OF RAW IMAGE DATA, CONTROL METHOD FOR IMAGE PROCESSING APPARATUS, AND STORAGE MEDIUM

(71) Applicant: CANON KABUSHIKI KAISHA, Tokyo (JP)

(72) Inventor: TATSUYA NISHIGUCHI, Kanagawa (JP)

(21) Appl. No.: 18/951,764

(22) Filed: Nov. 19, 2024

(30) Foreign Application Priority Data
Nov. 24, 2023 (JP) 2023-199054

(51) Int. Cl. G06T 1/00; G06F 21/64; G06T 7/90; G06T 11/00; G06V 20/00

(52) U.S. Cl. CPC G06T 1/0007; G06F 21/64; G06T 7/90; G06T 11/00; G06V 20/95; G06T 2207/10024; G06T 2210/32; G06V 2201/10

(57) ABSTRACT

An image processing apparatus capable of providing developed image data that can distinguish whether or not image editing has been performed in a development processing of RAW image data is provided. A digital camera performs a development processing on data included in a RAW image file designated by a user. The digital camera, in the case of being determined that image editing has not been performed in the development processing of the RAW image data determined to have not been falsified, adds information indicating that the image editing has not been performed to an image file including the developed image data, and in the case of being determined that the image editing has been performed in the development processing of the RAW image data determined to have not been falsified, adds information indicating that the image editing has been performed to the image file including the developed image data.

### CROSS-REFERENCE TO PRIORITY APPLICATION

This application claims the benefit of Japanese Patent Application No. 2023-199054, filed on Nov. 24, 2023, which is hereby incorporated by reference herein in its entirety.

### BACKGROUND OF THE INVENTION

### Field of the Invention

The present invention relates to an image processing apparatus, a control method for the image processing apparatus, and a storage medium.

### Description of the Related Art

Conventionally, in order to guarantee (ensure) that image data obtained by photographing with a digital camera has not been falsified, a digital camera, which has a function of adding authenticity guarantee information as verification data, has been proposed. In addition, as the related art, a technique disclosed in Japanese Laid-Open Patent Publication (Kokai) No. 2005-184046 has been proposed. In the technique disclosed in Japanese Laid-Open Patent Publication (Kokai) No. 2005-184046, when RAW image data photographed is developed to create JPEG image data, in the case that it is guaranteed that the original RAW image data has not been falsified, authenticity guarantee information, which guarantees that the original RAW image data has not been falsified, is added to the JPEG image data.

Incidentally, in a development processing of RAW image data, it is possible to create image data with the same image quality as at the time of photographing by using development parameters at the time of photographing as is. In addition, it is also possible to perform image editing, such as creating image data with a different image quality than at the time of photographing by using development parameters that have been changed since the time of photographing, or performing a trimming processing that adjusts a display range of image data to create image data with a different display range than at the time of photographing. Based on the authenticity guarantee information added to developed image data, that is, based on the authenticity guarantee information, which guarantees that the original RAW image data has not been falsified, it is not possible to distinguish whether or not the image editing has been performed with respect to this developed image data.

### SUMMARY OF THE INVENTION

The present invention provides an image processing apparatus capable of providing developed image data that is able to distinguish whether or not image editing has been performed in a development processing of RAW image data, a control method for the image processing apparatus, and a storage medium.

Accordingly, the present invention provides an image processing apparatus comprising at least one processor, and a memory coupled to the processor storing instructions that, when executed by the processor, cause the processor to function as an obtaining unit that obtains RAW image data generated by photographing, a processing unit that performs a development processing with respect to the RAW image data, a first determining unit that determines whether or not the RAW image data has been falsified, a second determining unit that determines whether or not image editing has been performed in the development processing, and a generating unit that generates an image file including developed image data generated by the development processing. The generating unit, in a case of being determined that the image editing has not been performed in a development processing of RAW image data that has been determined by the first determining unit to have not been falsified, adds information indicating that the image editing has not been performed to an image file including developed image data generated by the said development processing, and in a case of being determined that the image editing has been performed in a development processing of RAW image data that has been determined by the first determining unit to have not been falsified, adds information indicating that the image editing has been performed to an image file including developed image data generated by the said development processing.

According to the present invention, it is possible to provide the developed image data that is able to distinguish whether or not the image editing has been performed in the development processing of the RAW image data.

Further features of the present invention will become apparent from the following description of exemplary embodiments with reference to the attached drawings.

### BRIEF DESCRIPTION OF THE DRAWINGS

FIG. 1 is a block diagram that schematically shows a configuration of a digital camera as an image processing apparatus according to an embodiment of the present invention.

FIG. 2 is a diagram that shows an example of a structure of a still image RAW image file generated by the digital camera shown in FIG. 1.

FIG. 3 is a flowchart that shows the procedure of an authenticity guarantee information addition processing during a development processing, which is executed by the digital camera shown in FIG. 1.

### DESCRIPTION OF THE EMBODIMENTS

The present invention will now be described in detail below with reference to the accompanying drawings showing embodiments thereof.

Hereafter, a preferred embodiment of the present invention will be described in detail with reference to the accompanying drawings. It should be noted that the following preferred embodiment does not limit the present invention as defined by the claims. Although a plurality of features will be described in the following preferred embodiment, not all of the plurality of features are necessarily essential to the present invention, and the plurality of features may be combined in any desired manner. Furthermore, in the accompanying drawings, the same or similar configurations (components) will be given the same reference numerals and duplicated descriptions thereof will be omitted.

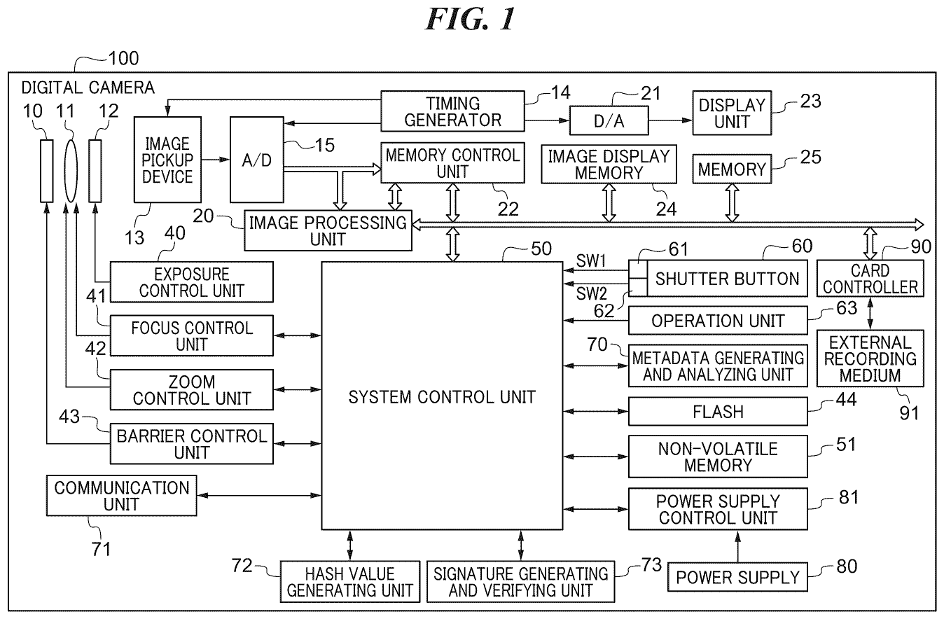

FIG. 1 is a block diagram that schematically shows a configuration of a digital camera 100 as an image processing apparatus according to the preferred embodiment of the present invention.

As shown in FIG. 1, a barrier 10 is a protective member that covers an image pickup unit including a photographing lens 11 of the digital camera 100 to prevent the image pickup unit from becoming dirty or damaged, and its operation is controlled by a barrier control unit 43. The photographing lens 11 causes to form an optical image on an image pickup surface of an image pickup device 13. A shutter 12 includes an aperture function. The image pickup device 13 is configured with, for example, a CCD image sensor, a CMOS image sensor, or the like, and converts the optical image that has been formed on the image pickup surface by the photographing lens 11 via the shutter 12 into electrical signals.

An A/D converter (simply referred to as “A/D” in FIG. 1) 15 converts analog image signal that has been outputted from the image pickup device 13 into digital image signals. The digital image signals converted by the A/D converter 15 are written into a memory 25 as so-called RAW image data. Additionally, development parameters corresponding to each piece of RAW image data are generated based on information at the time of photographing, and are written into the memory 25. The development parameters include various kinds of parameters used in image processing for recording in JPEG format or the like, such as exposure settings, a white balance, a color space, and a contrast.

A timing generator 14 is controlled by a memory control unit 22 and a system control unit 50, and supplies clock signals and control signals to the image pickup device 13, the A/D converter 15, and a D/A converter (simply referred to as “D/A” in FIG. 1) 21.

An image processing unit 20 performs various types of predetermined image processing such as a pixel interpolation processing, a color conversion processing, a correction processing, a resizing processing, and an image compositing processing with respect to the data outputted from the A/D converter 15 or the data outputted from the memory control unit 22. In addition, the image processing unit 20 performs the predetermined image processing and a predetermined calculation processing by using the image data obtained by picking up, and provides the obtained calculation results to the system control unit 50. The system control unit 50 realizes an autofocus processing (an AF processing), an autoexposure processing (an AE processing), and a pre-flash processing (an EF processing) by controlling an exposure control unit 40 and a focus control unit 41 based on the provided calculation results.

In addition, the image processing unit 20 performs a predetermined calculation processing by using the image data obtained by picking up, and performs an auto white balance processing (an AWB processing) based on the obtained calculation result. Furthermore, the image processing unit 20 reads the image data stored in the memory 25 and performs a compression processing such as lossless compression such as JPEG (Joint Photographic Experts Group), MPEG (Moving Picture Experts Group)-4 AVC (Advanced Video Coding), or HEVC (High Efficiency Video Coding) with respect to uncompressed RAW data, or a decompression processing. Then, the image processing unit 20 writes the processed image data into the memory 25.

In addition, the image processing unit 20 performs a predetermined calculation processing by using the image data obtained by picking up, and performs an editing processing of various types of image data. Specifically, it is possible to perform a trimming processing that adjusts a display range or a recording range of the image data by hiding unnecessary parts of the image data, and the resizing processing that enlarges or reduces the image data to change the number of recording pixels of the image data. Furthermore, it is possible to perform RAW development that performs the image processing such as the color conversion with respect to the data, with respect to which the compression processing such as the lossless compression with respect to the uncompressed RAW data or the decompression processing has been performed, and converts to JPEG or HEVC format to create image data. In addition, it is also possible to perform a video cutting-out processing that cuts out a designated frame in a video format such as MPEG-4, converts it into JPEG format, and saves it.

In addition, the image processing unit 20 performs a predetermined calculation processing by using the image data, and performs an image comparison processing of various types of image data. Specifically, the decompression processing is performed with respect to the image data to be compared in accordance with the compression method used in the image data to be compared, and the decompressed image data is compared with the image data to be compared. By such a comparison, it is determined whether or not the image data to be compared and the decompressed image data match, and in the case that the image data to be compared does not match the decompressed image data, it is determined how much difference there is between them.

In addition, the image processing unit 20 also performs, for example, a processing of superimposing on-screen display (OSD) such as menus and arbitrary characters to be displayed on a display unit 23 together with the image data for display.

In addition, the image processing unit 20 performs a subject detection processing that detects a subject area included in the image data by using the inputted image data and information on the distance to the subject obtained from the image pickup device 13 or the like at the time of photographing. The information that can be detected includes information such as the position and the size of the subject area in the image data, as well as information such as the inclination and likelihood.

Furthermore, the image processing unit 20 includes a compositing processing circuit that composites a plurality of pieces of image data. In the present embodiment, pixels may be overwritten or may be composited by weighted addition. By performing the weighted addition, the image data that allows the background to be seen through is obtained. In addition, it is possible to perform a comparative bright composition processing that selects pixels with the brightest value in each area of the image data to be composited and composites them to generate one piece of image data, or a comparative dark composition processing that selects pixels with the darkest value in each area of the image data to be composited and composites them to generate one piece of image data.

The memory control unit 22 controls the A/D converter 15, the timing generator 14, the image processing unit 20, an image display memory 24, the D/A converter 21, and the memory 25. The RAW image data generated by the A/D converter 15 is written into the image display memory 24 or the memory 25 via the image processing unit 20 and the memory control unit 22, or directly via the memory control unit 22.

The image data for display that has been written into the image display memory 24 is displayed on the display unit 23, which is configured with a thin film transistor liquid crystal display (a TFT-LCD) or the like, via the D/A converter 21. By sequentially displaying the image data obtained by picking up by using the display unit 23, it is possible to realize an electronic finder function that displays a live image.

The memory 25 has a storage capacity sufficient to store moving image data for a predetermined period of time and a predetermined number of pieces of still image data, and stores the photographed still image data and the photographed moving image data. In addition, the memory 25 is also able to be used as a working area for the system control unit 50.

The exposure control unit 40 controls the shutter 12 including the aperture function. The exposure control unit 40 also includes a flashlight control function by working with a flash 44. The focus control unit 41 performs focus adjustment by driving a focus lens (not shown) included in the photographing lens 11 based on an instruction from the system control unit 50. A zoom control unit 42 controls zooming by driving a zoom lens (not shown) included in the photographing lens 11. The flash 44 includes a function of projecting AF auxiliary light and the flashlight control function.

The system control unit 50 controls the entire digital camera 100. A non-volatile memory 51 is an electrically erasable and recordable non-volatile memory, and is, for example, an electrically erasable programmable read-only memory (an EEPROM). It should be noted that the non-volatile memory 51 records (stores) not only programs but also map information and the like.

A shutter switch 61 (SW1) is turned on in the middle of the operation of a shutter button 60, and issues an instruction to start operations such as the AF processing, the AE processing, the AWB processing, and the EF processing. A shutter switch 62 (SW2) is turned on when the operation of the shutter button 60 is completed, and issues an instruction to start a series of photographing operations including an exposure processing, a development processing, and a recording processing. In the exposure processing, the signals read out from the image pickup device 13 are written as the RAW image data into the memory 25 via the A/D converter 15 and the memory control unit 22. In the development processing, the RAW image data that has been written into the memory 25 is developed by using the calculations performed by the image processing unit 20 and the memory control unit 22, and the developed RAW image data is written as the image data into the memory 25. In the recording processing, the image data is read out from the memory 25, and is compressed by the image processing unit 20, and the compressed image data is stored in the memory 25 and then written into an external recording medium 91 via a card controller 90.

An operation unit 63 includes operation members such as various kinds of buttons and a touch panel. For example, the operation members include a power button, a menu button, a mode changeover switch for changing over between a photographing mode, a playback mode, and other special photographing modes, a cross key, a set button, a macro button, and a multi-screen playback page break button. In addition, for example, the operation members include a flash setting button, a single photographing/continuous photographing/self-timer switching button, a menu moving+(plus) button, a menu moving−(minus) button, a photographing image quality selection button, an exposure compensation button, a date/time setting button, etc.

When recording the image data on the external recording medium 91, a metadata generating and analyzing unit 70 generates various metadata to be attached to the image data in, for example, exchangeable image file format (Exif) standard, based on the information at the time of photographing. In addition, when reading the image data that has been recorded on the external recording medium 91, the metadata generating and analyzing unit 70 analyzes the metadata that has been assigned to the image data. Examples of the metadata include photographing setting information at the time of photographing, image data information related to the image data, and subject feature information included in the image data. In addition, when recording the moving image data, the metadata generating and analyzing unit 70 is also able to generate and assign metadata for each frame.

A power supply 80 is configured by a primary battery such as an alkaline battery or a lithium battery, a secondary battery such as a NiCd battery, a NiMH battery, or a lithium-ion battery, an AC adapter, or the like. A power supply control unit 81 supplies the power supplied from the power supply 80 to each unit (each component) of the digital camera 100.

The card controller 90 transmits and receives data to and from the external recording medium 91 such as a memory card. The external recording medium 91 is, for example, a memory card, and records the image data (the still image data and the moving image data) photographed by the digital camera 100.

A communication unit 71 includes a communication channel for performing transmission and reception. Specifically, the communication channel may be a wireless communication channel by, for example, Wi-Fi (registered trademark) or Bluetooth (registered trademark), or may be a wired communication channel by, for example, Ethernet (registered trademark) or a universal serial bus (USB).

A hash value generating unit 72 executes a hash function with respect to the image data that has been inputted via the system control unit 50 to generate (calculate) a hash value. Algorithms for generating a hash value include, for example, the secure hash algorithm 256-bit (SHA-256), the secure hash algorithm 384-bit (SHA-384), and the secure hash algorithm 512-bit (SHA-512). It should be noted that the system control unit 50 may generate the hash value instead of the hash value generating unit 72. In addition, a hash value may be generated by executing a hash function with respect to an image file instead of the image data.

A signature generating and verifying unit 73 generates and verifies signature information required for performing the determination of authenticity guarantee. When creating an image file, the signature generating and verifying unit 73 generates the signature information by using the hash value of the image data that has been generated by the hash value generating unit 72 and a signature generation key (a private key), and records the signature information in the image file as authenticity guarantee information. When detecting the falsification of the image file, the signature generating and verifying unit 73 verifies the hash value of the image data to be verified that has been generated by the hash value generating unit 72 and the signature information that has been recorded as the authenticity guarantee information by using a public key, and determines the presence or absence of falsification. Algorithms used for generating and verifying the signature information include, for example, the elliptic curve digital signature algorithm (ECDSA), the RSASSA-PSS signature algorithm, and the edwards-curve digital signature algorithm (EdDSA). It should be noted that the system control unit 50, rather than the signature generating and verifying unit 73, may generate and verify the signature information.

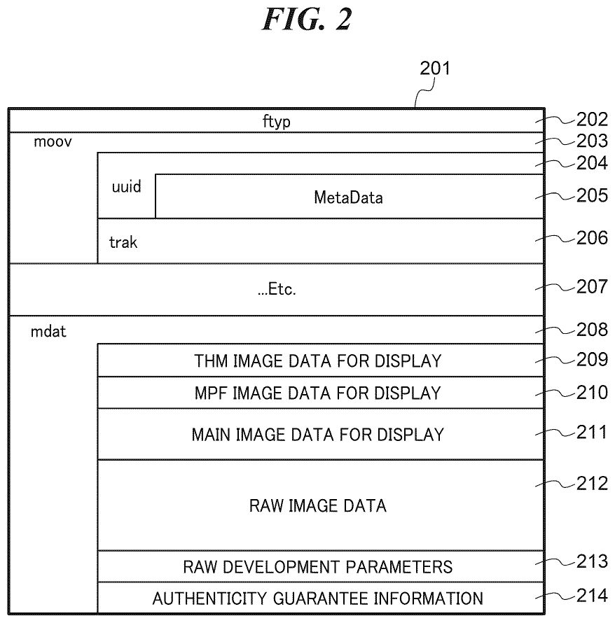

Next, a structure of a RAW image file including the authenticity guarantee information and the RAW image data (the still image data) that are recorded on the external recording medium 91 by the above-described recording processing is shown in FIG. 2. It should be noted that the file format of the image file exemplified below is the ISO base media file format defined in ISO/IEC14496-12. This file format has a tree structure, with each node called a box. In addition, each box is capable of having multiple boxes as child elements.

As shown in FIG. 2, a RAW image file 201 includes, at its beginning, an ftyp box 202 for describing the file type of the RAW image file 201. In addition, the RAW image file 201 includes a moov box 203 that includes all metadata, an mdat box 208 that is the main body of the media data of the track, and other boxes 207.

The moov box 203 includes, as child elements, a uuid box 204 that stores MetaData 205 and a trak box 206 that stores information indicating boxes stored in the mdat box 208. The MetaData 205 describes the metadata of the image data, and includes, for example, a creation date and time of the image data, conditions at the time of photographing, and other photographing information.

The mdat box 208 includes, as a child element, THM image data 209 for display, which is obtained by compressing developed image data by using JPEG or HEVC. In addition, the mdat box 208 includes, as child elements, MPF image data 210, main image data 211, RAW image data 212, RAW development parameters 213, and authenticity guarantee information 214. It should be noted that, in the digital camera 100 of the present embodiment, in the case that an authenticity guarantee mode has been set to disabled at the time of photographing, a RAW image file that does not include the authenticity guarantee information 214 is generated. On the other hand, in the case that the authenticity guarantee mode has been set to enabled at the time of photographing, as shown in FIG. 2, a RAW image file that includes the authenticity guarantee information 214 is generated. Specifically, a hash value of data including at least the RAW image data 212, the MetaData 205, and the RAW development parameters 213 is calculated by the hash value generating unit 72. Based on this hash value, signature information is generated by the signature generating and verifying unit 73 using the signature generation key (the private key), and this signature information is recorded in the RAW image file as the authenticity guarantee information 214. It should be noted that the hash value generating unit 72 may calculate a hash value of data including the THM image data 209, the MPF image data 210, and the main image data 211 in addition to the RAW image data 212, the MetaData 205, and the RAW development parameters 213.

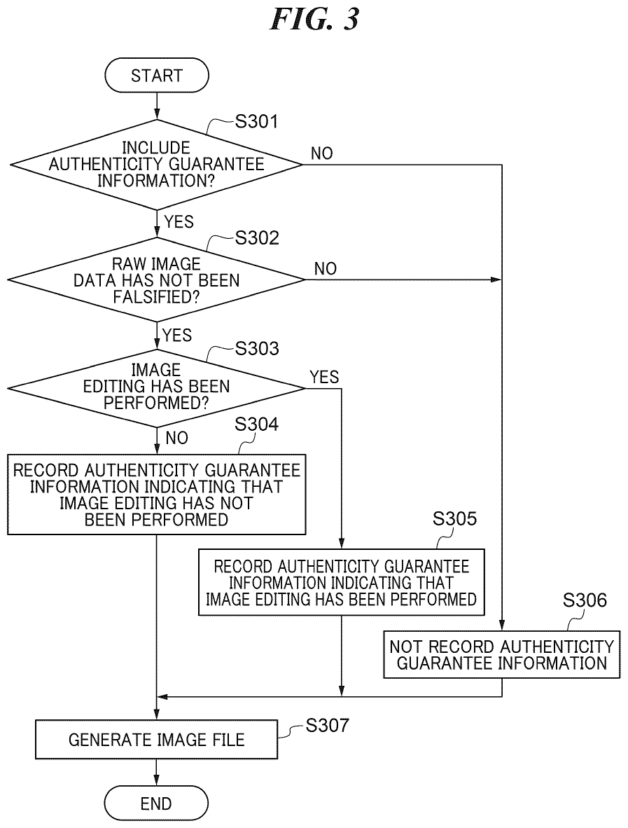

FIG. 3 is a flowchart that shows the procedure of an authenticity guarantee information addition processing during the development processing, which is executed by the digital camera 100 shown in FIG. 1. The authenticity guarantee information addition processing during the development processing shown in FIG. 3 is realized by the system control unit 50 executing a program that has been stored in the non-volatile memory 51 or the like. In the present embodiment, when a user selects a RAW development menu related to the development processing of the RAW image data by using the operation unit 63 and designates RAW image data that the user wants to develop from among a plurality of pieces of RAW image data generated by photographing, a setting screen (not shown) is displayed on the operation unit 63. On this setting screen, parameters that have been set at the time of photographing the designated RAW image data are displayed as the development parameters. It should be noted that the development parameters include, for example, the white balance, a color tone, a color density, the contrast, and a sharpness. When the user changes the individual development parameters on this setting screen and selects an image save menu (not shown), the development processing of the designated RAW image data is executed, the developed image data is generated, and the authenticity guarantee information addition processing during the development processing shown in FIG. 3 is executed.

As shown in FIG. 3, first, the system control unit 50 determines whether or not a RAW image file including the RAW image data designated by the RAW development menu includes the authenticity guarantee information 214 (S301). It should be noted that in the following description, the RAW image file including the RAW image data designated by the RAW development menu is simply referred to as “a designated RAW image file”.

In the case of being determined in S301 that the designated RAW image file does not include the authenticity guarantee information 214, the system control unit 50 does not record the authenticity guarantee information in the memory 25 (S306). Thereafter, the authenticity guarantee information addition processing during the development processing proceeds to S307, which will be described below.

In the case of being determined in S301 that the designated RAW image file includes the authenticity guarantee information 214, the system control unit 50 determines whether or not the RAW image data 212 included in the designated RAW image file has not been falsified (S302). In S302, the system control unit 50 controls the hash value generating unit 72 to calculate a hash value of data including the RAW image data 212 included in the designated RAW image file, the MetaData 205, and the RAW development parameters 213. In addition, the system control unit 50 uses the public key to obtain a hash value included in signature information constituting the authenticity guarantee information 214 included in the designated RAW image file. This hash value is a hash value calculated by executing the hash function with respect to data including the RAW image data 212, the MetaData 205, and the RAW development parameters 213 at the time of creating the designated RAW image file. The system control unit 50 controls the signature generating and verifying unit 73 to compare the calculated hash value with the hash value obtained from the authenticity guarantee information 214, thereby determining the presence or absence of falsification of the RAW image data 212 (determining whether or not the RAW image data 212 has been falsified). In the case that the calculated hash value and the obtained hash value do not match, it is determined that the RAW image data 212 has been falsified. In this case, the authenticity guarantee information addition processing during the development processing proceeds to S306 described above. On the other hand, in the case that the calculated hash value and the obtained hash value match, it is determined that the RAW image data 212 has not been falsified. In this case, the authenticity guarantee information addition processing during the development processing proceeds to S303.

In S303, the system control unit 50 determines whether or not image editing has been performed in the executed development processing. For example, in the case that the development parameters that have been set by the user through the operation unit 63 match the RAW development parameters 213 included in the designated RAW image file, that is, in the case that development parameters at the time of photographing have been used in this development processing, it is determined that the image editing has not been performed in this development processing. In this case, the authenticity guarantee information addition processing during the development processing proceeds to S304.

In S304, the system control unit 50 records, in the memory 25, authenticity guarantee information indicating that the image editing has not been performed in this development processing. Specifically, the system control unit 50 adds, to metadata of the developed image data, an editing information tag, in which a setting value “original (starting point)” indicating that the image editing has not been performed in this development processing has been set. In addition, the system control unit 50 controls the hash value generating unit 72 to calculate a hash value of data including the developed image data and the above-described metadata, and records this hash value in the memory 25 as the authenticity guarantee information indicating that the image editing has not been performed in this development processing. Thereafter, the authenticity guarantee information addition processing during the development processing proceeds to S307, which will be described below.

In S303, in the case that the development parameters that have been set by the user through the operation unit 63 do not match the RAW development parameters 213 included in the designated RAW image file, that is, in the case that development parameters that have been changed since the time of photographing have been used in the above development processing, it is determined that the image editing has been performed in the above development processing. In this case, the authenticity guarantee information addition processing during the development processing proceeds to S305.

In S305, the system control unit 50 records, in the memory 25, authenticity guarantee information indicating that the image editing has been performed in the above development processing. Specifically, the system control unit 50 adds, to the metadata of the developed image data, an editing information tag, in which a setting value “already edited” indicating that the image editing has been performed in the above development processing has been set. In addition, the system control unit 50 controls the hash value generating unit 72 to calculate a hash value of data including the developed image data and its metadata, and records this hash value in the memory 25 as the authenticity guarantee information indicating that the image editing has been performed in the above development processing. Thereafter, the authenticity guarantee information addition processing during the development processing proceeds to S307, which will be described below.

In S307, the system control unit 50 generates an image file including the developed image data and the authenticity guarantee information that has been recorded in the memory 25 in S304 or S305. The system control unit 50 saves (stores) the generated image file in the external recording medium 91. Thereafter, the authenticity guarantee information addition processing during the development processing ends.

According to the embodiment described above, in the case of being determined that the image editing has not been performed in the development processing of the RAW image data 212 that has been determined to have not been falsified, the authenticity guarantee information indicating that the image editing has not been performed is added to the image file including the developed image data generated by the said development processing. In addition, in the case of being determined that the image editing has been performed in the development processing of the RAW image data 212 that has been determined to have not been falsified, the authenticity guarantee information indicating that the image editing has been performed is added to the image file including the developed image data generated by the said development processing. As a result, it is possible to provide the developed image data that is able to distinguish whether or not the image editing has been performed in the development processing of the RAW image data.

In addition, in the embodiment described above, by using the RAW image data 212, the MetaData 205, the RAW development parameters 213, and the authenticity guarantee information 214 that are included in the designated RAW image file, whether or not the RAW image data 212 has been falsified is determined. As a result, it is possible to determine the presence or absence of the falsification of the RAW image data 212 by using only the information included in the designated RAW image file.

In addition, in the embodiment described above, in the case that the development parameters at the time of photographing have been used in the development processing of the RAW image data 212 that has been determined to have not been falsified, it is determined that the image editing has not been performed in the said development processing. In addition, in the case that the development parameters that have been changed since the time of photographing have been used in the development processing of the RAW image data 212 that has been determined to have not been falsified, it is determined that the image editing has been performed in the said development processing. As a result, it is possible to provide the developed image data that is able to distinguish whether or not the image editing of creating image data with a different image quality than at the time of photographing by using the development parameters that have been changed since the time of photographing has been performed in the development processing of the RAW image data.

In addition, in the embodiment described above, the development parameters are parameters related to at least one of the white balance, the color tone, the color density, the contrast, and the sharpness. As a result, it is possible to provide the developed image data that is able to distinguish whether or not the image editing by changing these parameters since the time of photographing has been performed.

Although the present invention has been described by using the embodiment described above, the present invention is not limited to the embodiment described above. For example, when an aspect ratio is changed at the time of photographing and then a portion of the original image data is cut out and trimmed at the time of development and saved, the authenticity guarantee information indicating that the image editing has been performed may be added to the image file including the developed image data.

Specifically, a photographer (the user) is able to select the setting of the aspect ratio of the image data to be photographed from among, for example, [3:2 (FULL)], [4:3], [16:9], and [1:1]. The RAW image data is saved with an aspect ratio of [3:2] regardless of the setting of the aspect ratio. On the other hand, when the aspect ratio has been set to [4:3], [16:9], or [1:1], the image data with the area outside the range of the set aspect ratio masked in black with respect to the development result of the RAW image data is displayed on the LCD monitor of the operation unit 63. In addition, when the aspect ratio has been set to [4:3], [16:9], or [1:1], as the development result of the RAW image data, JPEG image data corresponding to within the range of the set aspect ratio with respect to the development result of the RAW image data is saved. It should be noted that information about the set aspect ratio is added to and saved in the RAW image file. It should be noted that in such a configuration, for example, in the authenticity guarantee information addition processing during the development processing, which has been described above, in S303, in the case that the trimming processing has been performed in the above development processing, it is determined that the image editing has been performed in the above development processing. In addition, in the case that the trimming processing has not been performed in the above development processing, that is, in the case that the aspect ratio has been set to [3:2 (FULL)], it may be determined that the image editing has not been performed in the above development processing. By controlling in this way, it is possible to provide the developed image data that is able to distinguish whether or not the image editing of performing the trimming processing in the above development processing has been performed.

Alternatively, in the case of wanting to guarantee the authenticity regarding the fact that it is from the time of photographing, when the photographer changes the aspect ratio at the time of photographing and then cuts out and trims a portion of the original image data at the time of development and saves, regardless of the setting of the aspect ratio, the authenticity guarantee information indicating that the image editing has not been performed may be added to the image file including the developed image data. In addition, in the case that the trimming processing has been performed in the development processing in response to a desired position designated by the photographer after photographing rather than the setting of the aspect ratio, it may be determined that the image editing has been performed.

In addition, in the present embodiment, in the case that a processing of changing an image size has been performed in the development processing of the RAW image data 212 that has been determined to have not been falsified, the authenticity guarantee information indicating that the image editing has not been performed may be added to the image file including the developed image data generated by the said development processing. In this way, it is possible to add the information that guarantees that the image editing has not been performed to the image file including the developed image data, in which only the image size has been changed and the image quality and the display range remain the same as the time of photographing.

It should be noted that in the present embodiment, although the digital camera has been described as an example of the image processing apparatus, the image processing apparatus is not limited to a digital camera. The image processing apparatus may be an apparatus equipped with a photographing function, such as a smartphone, a tablet terminal, or the like. As a result, in a configuration in which the generation and the development of the RAW image data are performed by one apparatus, it is possible to provide the developed image data that is able to distinguish whether or not the image editing has been performed in the development processing of the RAW image data.

In addition, in the present embodiment, the image processing apparatus may be an information processing apparatus such as a personal computer (a PC) that obtains, from an image pickup apparatus that photographs a subject and generates RAW image data, the RAW image data, and performs a development processing with respect to the RAW image data by using the same algorithm as that used by the image pickup apparatus. As a result, in a configuration in which the generation and the development of the RAW image data are performed by separate apparatuses, it is possible to provide the developed image data that is able to distinguish whether or not the image editing has been performed in the development processing of the RAW image data.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An image processing apparatus comprising:
at least one processor; and
a memory coupled to the processor storing instructions that, when executed by the processor, cause the processor to function as:
an obtaining unit that obtains RAW image data generated by photographing;
a processing unit that performs a development processing with respect to the RAW image data;
a first determining unit that determines whether or not the RAW image data has been falsified;
a second determining unit that determines whether or not image editing has been performed in the development processing; and
a generating unit that generates an image file including developed image data generated by the development processing,
wherein the generating unit, in a case of being determined that the image editing has not been performed in a development processing of RAW image data that has been determined by the first determining unit to have not been falsified, adds information indicating that the image editing has not been performed to an image file including developed image data generated by the said development processing, and,
in a case of being determined that the image editing has been performed in a development processing of RAW image data that has been determined by the first determining unit to have not been falsified, adds information indicating that the image editing has been performed to an image file including developed image data generated by the said development processing.

2. The image processing apparatus according to claim 1, wherein the obtaining unit obtains an image file including the RAW image data, development parameters used in generating the RAW image data, metadata recording information at a time of photographing, and authenticity guarantee information that guarantees authenticity of the RAW image data, and
the first determining unit determines whether or not the RAW image data has been falsified by using the authenticity guarantee information, the RAW image data, the development parameters, and the metadata.

3. The image processing apparatus according to claim 1, wherein the second determining unit, in a case that development parameters at a time of photographing have been used in a development processing of RAW image data that has been determined by the first determining unit to have not been falsified, determines that image editing has not been performed in the said development processing, and
in a case that development parameters that have been changed since the time of photographing have been used in a development processing of RAW image data that has been determined by the first determining unit to have not been falsified, determines that image editing has been performed in the said development processing.

4. The image processing apparatus according to claim 3, wherein the development parameters are parameters related to at least one of a white balance, a color tone, a color density, a contrast, and a sharpness.

5. The image processing apparatus according to claim 1, wherein the second determining unit, in a case that a trimming processing has not been performed in a development processing of RAW image data that has been determined by the first determining unit to have not been falsified, determines that image editing has not been performed in the said development processing, and,
in a case that the trimming processing has been performed in a development processing of RAW image data that has been determined by the first determining unit to have not been falsified, determines that image editing has been performed in the said development processing.

6. The image processing apparatus according to claim 5, wherein the trimming processing is performed based on an aspect ratio that has been set at a time of photographing.

7. The image processing apparatus according to claim 1, wherein the generating unit, in a case that a processing of changing an image size has been performed in a development processing of RAW image data that has been determined by the first determining unit to have not been falsified, adds the information indicating that the image editing has not been performed to an image file including developed image data generated by the said development processing.

8. The image processing apparatus according to claim 1, wherein the image processing apparatus is an image pickup apparatus that photographs a subject and generates RAW image data.

9. The image processing apparatus according to claim 1, wherein the image processing apparatus is an information processing apparatus that obtains, from an image pickup apparatus that photographs a subject and generates RAW image data, the RAW image data, and performs a development processing with respect to the obtained RAW image data by using the same algorithm as that used by the image pickup apparatus.

10. A control method for an image processing apparatus, the control method comprising:
a step of obtaining RAW image data generated by photographing;
a step of performing a development processing with respect to the RAW image data;
a first determining step of determining whether or not the RAW image data has been falsified;
a second determining step of determining whether or not image editing has been performed in the development processing; and
a generating step of generating an image file including developed image data generated by the development processing,
wherein in the generating step, in a case of being determined that the image editing has not been performed in a development processing of RAW image data that has been determined in the first determining step to have not been falsified, information indicating that the image editing has not been performed is added to an image file including developed image data generated by the said development processing, and,
in a case of being determined that the image editing has been performed in a development processing of RAW image data that has been determined in the first determining step to have not been falsified, information indicating that the image editing has been performed is added to an image file including developed image data generated by the said development processing.

11. A non-transitory computer-readable storage medium storing a program for causing a computer to execute a control method for an image processing apparatus, the control method comprising:
a step of obtaining RAW image data generated by photographing;
a step of performing a development processing with respect to the RAW image data;
a first determining step of determining whether or not the RAW image data has been falsified;
a second determining step of determining whether or not image editing has been performed in the development processing; and
a generating step of generating an image file including developed image data generated by the development processing,
wherein in the generating step, in a case of being determined that the image editing has not been performed in a development processing of RAW image data that has been determined in the first determining step to have not been falsified, information indicating that the image editing has not been performed is added to an image file including developed image data generated by the said development processing, and,
in a case of being determined that the image editing has been performed in a development processing of RAW image data that has been determined in the first determining step to have not been falsified, information indicating that the image editing has been performed is added to an image file including developed image data generated by the said development processing.
